(19) United States
(12) Patent Application Publication
(10) Pub. No.: US 2025/0367892 A1
(43) Pub. Date: Dec. 4, 2025

(54) FORMING AIRCRAFT COMPONENT WITH LIGHTNING STRIKE PROTECTION

(71) Applicant: Rohr, Inc., Chula Vista, CA (US)

(72) Inventors: Michael van Tooren, San Diego, CA (US); Shyan Bob Shen, San Diego, CA (US)

(21) Appl. No.: 18/732,437

(22) Filed: Jun. 3, 2024

(51) Int. Cl. B29C 70/88; B29C 35/02; B29C 35/08; B29C 70/70; B29K 105/08; B29K 105/20; B29K 705/10; B29L 31/30; B32B 3/08; B32B 15/02; B32B 15/08; B32B 15/20; B32B 27/18; B64D 45/02

(52) U.S. Cl. CPC B29C 70/882; B29C 35/02; B29C 70/70; B32B 3/085; B32B 15/02; B32B 15/08; B32B 15/20; B32B 27/18; B64D 45/02; B29C 2035/0211; B29C 35/08; B29C 2035/0811; B29C 2035/0822; B29K 2105/08; B29K 2105/206; B29K 2705/10; B29K 2995/0003; B29L 2031/3076; B32B 2307/202; B32B 2605/18

(57) ABSTRACT

A formation method is provided during which a lightning strike protection and thermoplastic material are arranged on a tool. The lightning strike protection includes a plurality of interconnected conductive elements. A thermoplastic composite structure is arranged over the lightning strike protection and the thermoplastic material with the lightning strike protection and the thermoplastic material between the tool and the thermoplastic composite structure. The tool is heated to provide a heated tool. The thermoplastic material is heated using the heated tool to melt the thermoplastic material and bond the lightning strike protection layer to the thermoplastic composite structure.

### BACKGROUND

### 1. Technical Field

This disclosure relates generally to lightning strike protection and, more particularly, to providing an aircraft component with lightning strike protection.

### 2. Background Information

Various methods are known in the art for providing a thermoplastic composite aircraft component with lightning strike protection. While these known methods have various benefits, there is still room in the art for improvement.

### SUMMARY OF THE DISCLOSURE

According to an aspect of the present disclosure, a formation method is provided during which a lightning strike protection and thermoplastic material are arranged on a tool. The lightning strike protection includes a plurality of interconnected conductive elements. A thermoplastic composite structure is arranged over the lightning strike protection and the thermoplastic material with the lightning strike protection and the thermoplastic material between the tool and the thermoplastic composite structure. The tool is heated to provide a heated tool. The thermoplastic material is heated using the heated tool to melt the thermoplastic material and bond the lightning strike protection layer to the thermoplastic composite structure.

According to another aspect of the present disclosure, another formation method is provided during which a lightning strike protection layer is arranged over a metal conductor. A pre-consolidated fiber reinforced thermoplastic structure is arranged over the lightning strike protection layer with the lightning strike protection layer between the metal conductor and the pre-consolidated fiber reinforced thermoplastic structure. The metal conductor is heated to provide a heated metal conductor. The lightning strike protection layer is heated using the heated metal conductor to melt thermoplastic material of the pre-consolidated fiber reinforced thermoplastic structure and bond the lightning strike protection layer to the pre-consolidated fiber reinforced thermoplastic structure to form an aircraft component. The aircraft component is removed from the metal conductor.

According to still another aspect of the present disclosure, another formation method is provided during which a lightning strike protection layer is arranged over a metal conductor. A thermoplastic composite structure is arranged over the lightning strike protection layer. The thermoplastic composite structure includes a skin and a structural member connected to and projecting out from the skin. The lightning strike protection layer is between and engages the metal conductor and the skin. The metal conductor is heated to provide a heated metal conductor. The lightning strike protection layer is heated using the heated metal conductor to melt thermoplastic material of the thermoplastic composite structure and bond the lightning strike protection layer to the skin to form an aircraft component. The aircraft component is removed from the metal conductor.

The lightning strike protection layer may include a metal mesh embedded within thermoplastic material of the lightning strike protection layer.

The thermoplastic composite structure may include second thermoplastic material and fiber reinforcement embedded within the second thermoplastic material of the thermoplastic composite structure. The formation method may also include conductive heating the thermoplastic composite structure through the lightning strike protection and the thermoplastic material using the heated tool to melt a portion of the second thermoplastic material of the thermoplastic composite structure adjacent the lightning strike protection and further bond the lightning strike protection to the thermoplastic composite structure.

The thermoplastic material and the second thermoplastic material may be a common (the same) type of thermoplastic material.

The heating of the tool may include heating the tool with a heating device to provide the heated tool. The heated tool may be disposed between the heating device and a stack of the lightning strike protection, the thermoplastic material and the thermoplastic composite structure.

The heating device may be configured as or otherwise include an infrared heating device.

The heating device may be configured as or otherwise include an electrical heating device.

The heating device may be configured as or otherwise include an induction heating device and/or a conduction heating device.

The heating of the tool may include directing a heated gas against the tool to provide the heated tool.

The formation method may also include biasing the thermoplastic composite structure towards the heated tool to press the lightning strike protection and the thermoplastic material between the tool and the thermoplastic composite structure.

The thermoplastic composite structure may be biased towards the heated tool using a vacuum bag.

The lightning strike protection may be bonded to the thermoplastic composite structure to form an aircraft component with integrated lightning strike protection.

A lightning strike protection layer may include the lightning strike protection and the thermoplastic material. The interconnected conductive elements may be embedded within the thermoplastic material prior to arranging the lightning strike protection and the thermoplastic material on the tool.

The lightning strike protection layer may also include fiber reinforcement

The lightning strike protection layer may be configured without any fiber reinforcement.

The lightning strike protection layer may alternatively only include a plurality of interconnected conductive elements.

The lightning strike protection layer may contact the tool. In addition or alternatively, the lightning strike protection layer may contact the thermoplastic composite structure.

The formation method may also include disposing a thermoplastic film between the tool and the lightning strike protection or between the lightning strike protection and the thermoplastic composite structure. The thermoplastic film may be configured from or otherwise include the thermoplastic material.

The thermoplastic composite structure may include a skin and a structural member connected and projecting out from the skin. The skin may be arranged over the lightning strike protection with the skin between the lightning strike protection and the structural member. The heating of the thermoplastic material may bond the lightning strike protection to the skin.

The thermoplastic composite structure may be an original manufactured part.

The formation method may also include repairing the thermoplastic composite structure prior to performing the arranging of the thermoplastic composite structure on the lightning strike protection.

The present disclosure may include any one or more of the individual features disclosed above and/or below alone or in any combination thereof.

The foregoing features and the operation of the invention will become more apparent in light of the following description and the accompanying drawings.

### BRIEF DESCRIPTION OF THE DRAWINGS

FIG. 1 is a schematic illustration of an aircraft.

FIG. 2 is a partial sectional illustration of an aircraft component with a thermoplastic composite structure and a lightning strike protection (LSP) layer.

FIG. 3 is a partial perspective illustration of the thermoplastic composite structure.

FIG. 4 is a partial closeup illustration of layers forming the aircraft component including a single lightning strike protection (LSP) layer.

FIG. 5 is a partial plan view illustration of lightning strike protection mesh.

FIG. 6 is a partial closeup illustration of layers forming the aircraft component including multiple lightning strike protection (LSP) layers.

FIG. 7 is a flow diagram of a method for forming an aircraft component.

FIGS. 8A-F are illustrations depicting a sequence of steps for forming the aircraft component.

FIG. 9 is a partial sectional illustration of a lightning strike protection (LSP) layer between multiple thermoplastic films during bonding to a thermoplastic composite structure.

FIGS. 10A-C are illustrations depicting a sequence of steps for repairing a damaged thermoplastic composite structure.

FIG. 11 is an illustration depicting a repaired thermoplastic composite structure.

### DETAILED DESCRIPTION

The present disclosure includes methods for forming a thermoplastic composite component of an aircraft with integrated lightning strike protection. The term “forming” may describe a method for original manufacture of the aircraft component; e.g., creating a brand new aircraft component. The term “forming” may also or alternatively describe a method for remanufacture or otherwise repairing of the aircraft component; e.g., restoring one or more features of a previously formed aircraft component to brand new condition, similar to brand new condition, better than brand new condition, etc.

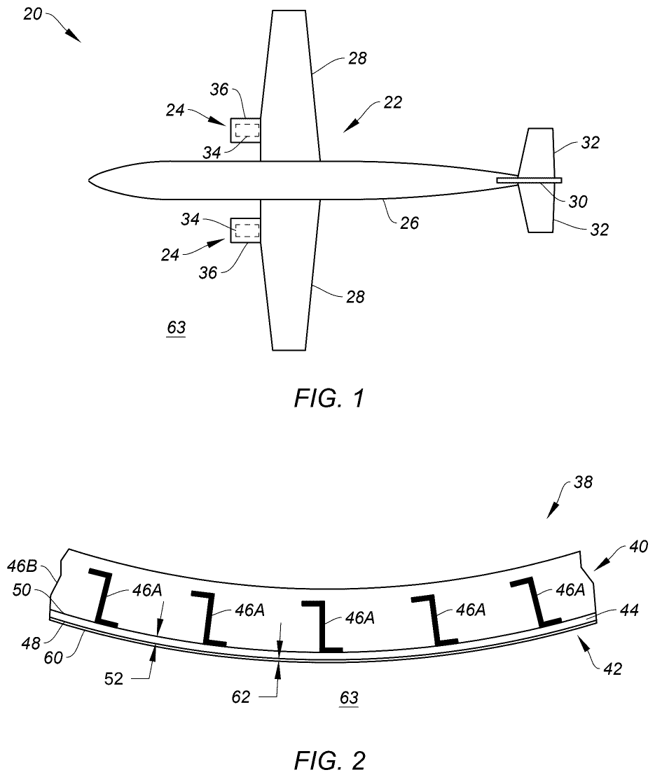

The aircraft may be an airplane, a helicopter, a drone (e.g., an unmanned aerial vehicle (UAV)), a missile, a rocket, or any other manned or unmanned aerial or aerospace vehicle or system. However, for ease of description, the aircraft may be generally described below as an airplane. An exemplary embodiment of such an aircraft 20 is shown in FIG. 1. This aircraft 20 includes an airframe 22 and one or more propulsion systems 24. The aircraft airframe 22 of FIG. 1 includes a fuselage 26, one or more wings 28, and one or more stabilizers 30 and 32. Each aircraft propulsion system 24 may include a power unit 34 partially or completely housed within a nacelle 36. Examples of the power unit 34 include, but are not limited to, a turbofan engine, a turboprop engine, a turbojet engine, a turboshaft engine, a rotary engine (e.g., a Wankel engine), a reciprocating piston engine, a hybrid powerplant and an electric motor.

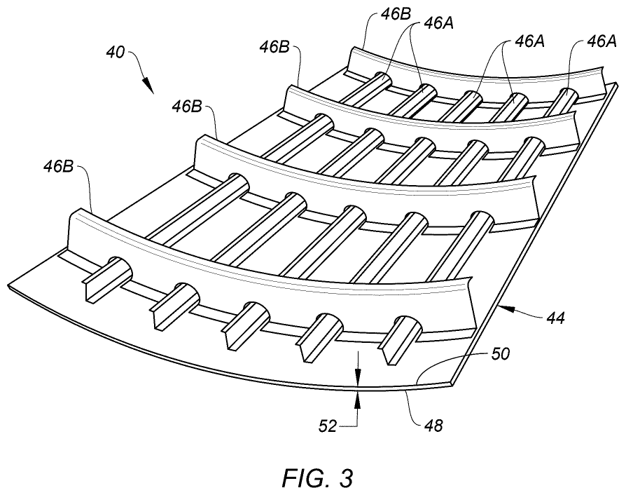

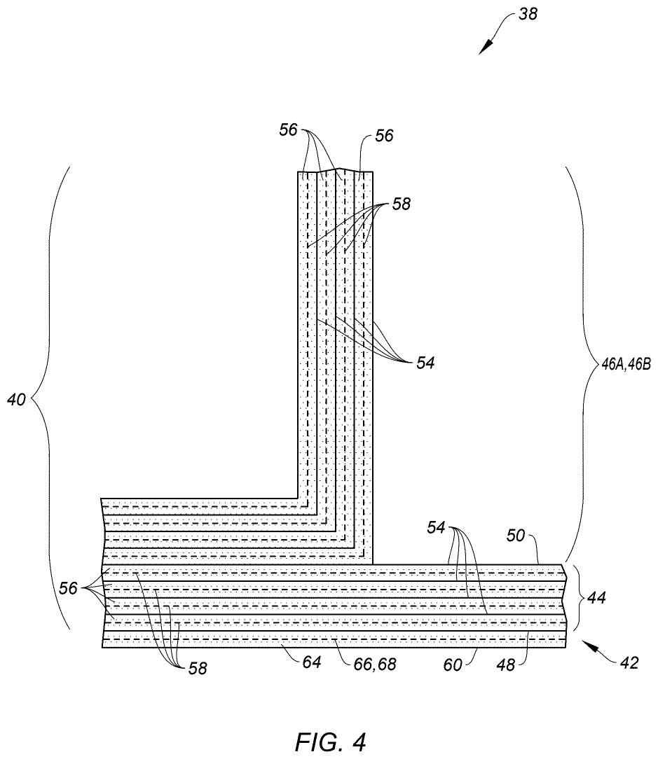

The formation methods of the present disclosure may be used to form various aircraft components. Such an aircraft component, for example, may be configured as or otherwise included as part of the aircraft fuselage 26, one of the aircraft wings 28, the vertical aircraft stabilizer 30, one of the horizontal aircraft stabilizers 32, the propulsion system nacelle 36, or any other thermoplastic composite member of the aircraft 20 which includes lightning strike protection. An exemplary embodiment of such an aircraft component 38 is shown in FIG. 2. This aircraft component 38 of FIG. 2 includes a thermoplastic composite structure 40 and an exterior lightning strike protection (LSP) layer 42 bonded to the thermoplastic composite structure 40. The thermoplastic composite structure 40 of FIG. 3 includes a skin 44 and one or more structural members 46A and 46B (generally referred to as “46”) for structurally supporting and/or reinforcing the skin 44.

The skin 44 extends vertically between an exterior side 48 of the skin 44 and an interior side 50 of the skin 44. The skin 44 extends laterally in a first direction as well as laterally in a second direction. A vertical dimension 52 of the skin 44 is (e.g., significantly) smaller than a lateral first direction dimension of the skin 44 and/or a lateral second direction dimension of the skin 44 providing the skin 44 with a generally planar (e.g., sheet-like) geometry. This skin geometry may be a curved (e.g., arcuate) geometry. For example, the vertical direction of FIG. 3 is a radial direction, the first lateral direction is an axial direction, and the second lateral direction is a circumferential direction. While the skin 44 is shown in FIG. 3 as a two-dimensionally curved member of the thermoplastic composite structure 40, the present disclosure is not limited thereto. For example, the skin 44 may alternatively be a three-dimensionally curved member of the thermoplastic composite structure 40, or alternatively a flat member of the thermoplastic composite structure 40.

Each of the structural members 46 may be formed integral with, bonded to or otherwise fixedly connected to the skin 44. Each of the structural members 46 projects vertically out from the skin 44 and its skin interior side 50, for example to a distal side of the respective structural member 46. Each of the structural members 46 extends longitudinally (e.g., in the first lateral direction and/or the second lateral direction) along the skin 44. The first structural members 46A may be arranged parallel with one another. Similarly, the second structural members 46B may be arranged parallel with one another. The second structural members 46B of FIG. 3, however, are angularly offset from (e.g., perpendicular to, acute to, etc.) the first structural members 46A. With this arrangement, the structural members 46 may be interconnected to form a frame, a truss and/or another structure for structurally supporting and/or reinforcing the skin 44. These structural members 46 may also (or may not) structurally support one or more other members of the aircraft 20 (see FIG. 1). Examples of the structural members 46 include, but are not limited to, stiffeners, ribs, stringers, spars, beams, etc.

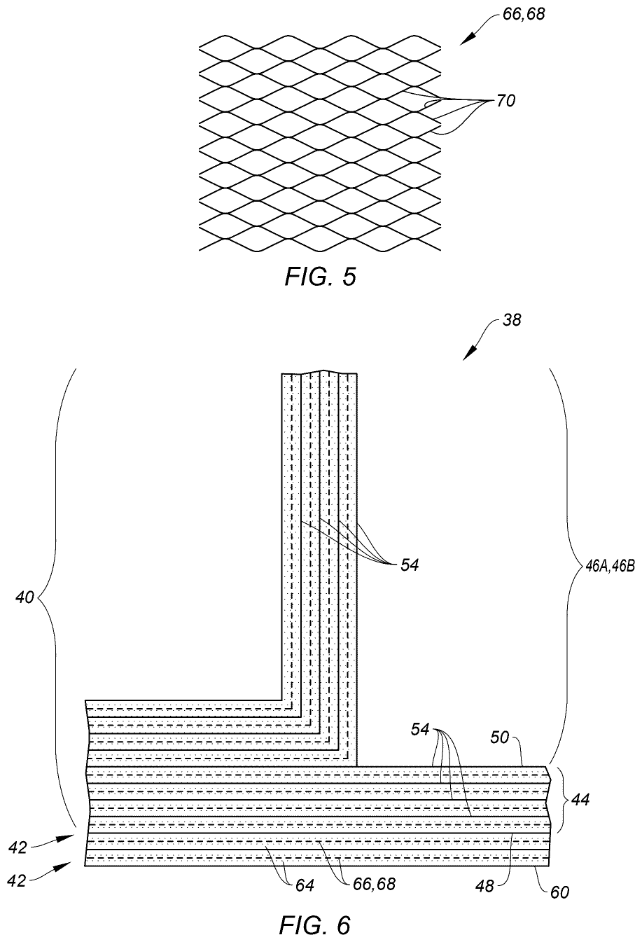

Referring to FIG. 4, the thermoplastic composite structure 40 and each of its members 44, 46A, 46B may be formed from one or more consolidated layers 54 of thermoplastic composite material. Each thermoplastic composite structure (TCS) layer 54, for example, includes a thermoplastic matrix 56 and fiber reinforcement 58 embedded within the thermoplastic matrix 56. The thermoplastic matrix 56 is a thermoplastic material (e.g., a thermoplastic resin) such as, but not limited to, thermoplastic film polyamide (PA), polyamide-imide (PAI), polyarylsulfone (PAS), polyethersulfone (PES), polyoxymethylene (POM), polyphenylene sulfide (PPS), polyether ether ketone (PEEK), polyetherimide (PEI), polyethylene terephthalate (PET), polyphthalamide (PPA), poly ether ketone ketone (PEKK), or poly aryl ether ketone (PAEK). The fiber reinforcement 58 may be or otherwise include fiberglass fibers, carbon fiber fibers, aramid (e.g., Kevlar®) fibers and/or the like. This fiber reinforcement 58 may be arranged as a (e.g., unidirectional, woven or unwoven) sheet of fibers and/or chopped fibers. The present disclosure, however, is not limited to such exemplary materials nor such a layered construction.

Referring to FIG. 2, the LSP layer 42 is vertically next to the thermoplastic composite structure 40 and its skin 44 at the skin exterior side 48. The LSP layer 42 of FIG. 2, for example, is bonded directly to the skin 44 at the skin exterior side 48. Note, while the LSP layer 42 and the skin 44 are schematically shown in FIG. 2 as separate members of the aircraft component 38, the LSP layer 42 may actually become an integral part of the skin 44 after the LSP layer 42 is bonded to the thermoplastic composite structure 40 and its skin 44 as described below in further detail. Referring again to FIG. 2, the LSP layer 42 projects vertically out from the skin 44 to an exterior surface 60. Briefly, this exterior surface 60 may be an aerodynamic exterior flow surface of the aircraft component 38 exposed to (e.g., in fluid contact with) air flowing along the aircraft component 38 during aircraft operation. Here, a vertical dimension 62 of the LSP layer 42 is smaller than the vertical dimension 52 of the skin 44. The vertical dimension 52 of the skin 44, for example, may be five times (5×), ten times (10×), fifteen times (15×), or more larger than the vertical dimension 62 of the LSP layer 42. The present disclosure, however, is not limited to such an exemplary dimensional relationship between the LSP layer 42 and the skin 44. In other embodiments, for example, it is contemplated the vertical dimension 52 of the skin 44 may be less than five times (5×) larger than the vertical dimension 62 of the LSP layer 42.

The LSP layer 42 of FIG. 2 extends laterally in the lateral first direction and in the lateral second direction along the skin 44. The LSP layer 42 may thereby partially or completely cover the skin 44 in the lateral first direction and/or in the lateral second direction. With this arrangement, the LSP layer 42 may provide a physical barrier as well as a lightning strike protection buffer between (a) the thermoplastic composite structure 40 and its skin 44 and (b) an environment 63 external to and adjacent to the aircraft component 38.

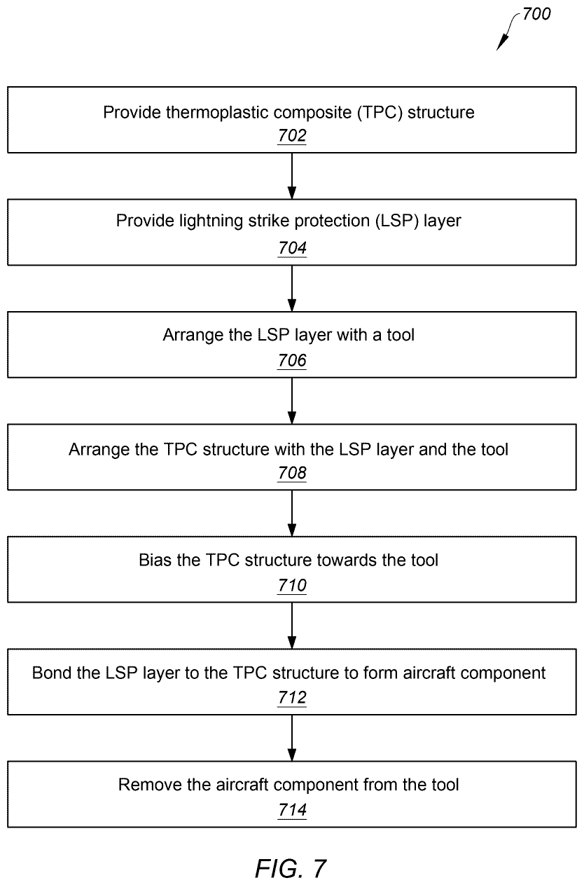

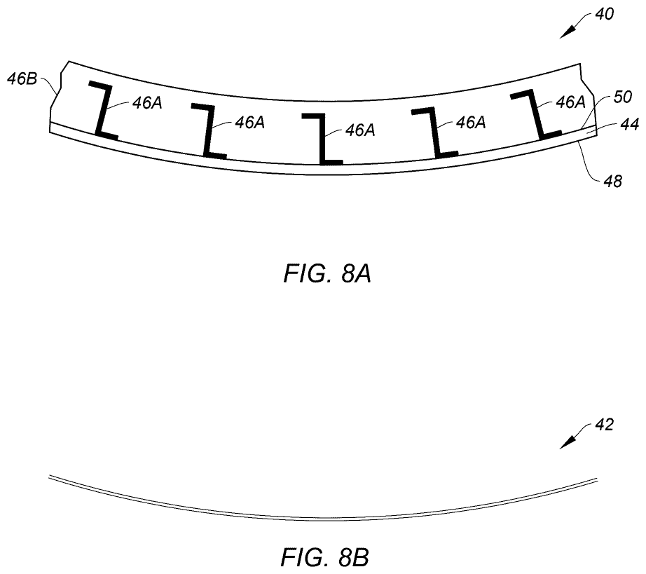

Referring to FIG. 4, the LSP layer 42 includes a thermoplastic matrix 64 and lightning strike protection 66 embedded within the thermoplastic matrix 64; e.g., without any fiber reinforcement. However, it is contemplated the LSP layer 42 may alternatively be configured without the thermoplastic matrix 64 in other embodiments. Referring again to FIG. 4, the thermoplastic matrix 64 is a thermoplastic material (e.g., a thermoplastic resin) such as, but not limited to, thermoplastic film polyamide (PA), polyamide-imide (PAI), polyarylsulfone (PAS), polyethersulfone (PES), polyoxymethylene (POM), polyphenylene sulfide (PPS), polyether ether ketone (PEEK), polyetherimide (PEI), polyethylene terephthalate (PET), polyphthalamide (PPA), poly ether ketone ketone (PEKK), or poly aryl ether ketone (PAEK). This thermoplastic matrix 64/thermoplastic material of the LSP layer 42 may be the same as (or different than, but bondable with) the thermoplastic matrix 56/thermoplastic material of the thermoplastic composite structure 40 and its members 44, 46A, 46B. The lightning strike protection 66 may be configured as a conductive mesh 68; e.g., a grid, a screen, a piece of expanded foil, etc. This conductive mesh 68 may be formed from metal such as copper. Referring to FIG. 5, the lightning strike protection 66 and its conductive mesh 68 may include a plurality of interconnected conductive elements 70; e.g., struts, wires, etc. The present disclosure, however, is not limited to such exemplary materials nor such a construction. For example, while the aircraft component 38 is configured with a single LSP layer 42 in FIG. 4, it is contemplated a stack of multiple LSP layers 42 may be bonded to the skin 44 as shown, for example, in FIG. 6.

Referring to FIG. 3, prior to bonding the LSP layer 42 (see FIG. 2) to the thermoplastic composite structure 40, the thermoplastic composite structure 40 may be configured as a preform of the aircraft component 38. The thermoplastic composite structure 40, for example, may provide the aircraft component 38 with its general geometry; e.g., shape, dimensions, etc. The thermoplastic composite structure 40 may also be self-supported and provide the aircraft component 38 with its structural form and rigidity. By contrast, the LSP layer 42 of FIG. 2 may be included to (e.g., simply) provide the aircraft component 38 with its integrated lightning strike protection and/or form the finished exterior surface 60 of the aircraft component 38 over the thermoplastic composite structure 40. That said, by affectively increasing the vertical thickness of the skin 44, the LSP layer 42 of FIG. 2 may also increase a structural integrity and/or rigidity of the skin 44 and thereby the aircraft component 38. The present disclosure, however, is not limited to the foregoing exemplary aircraft component configuration or construction.

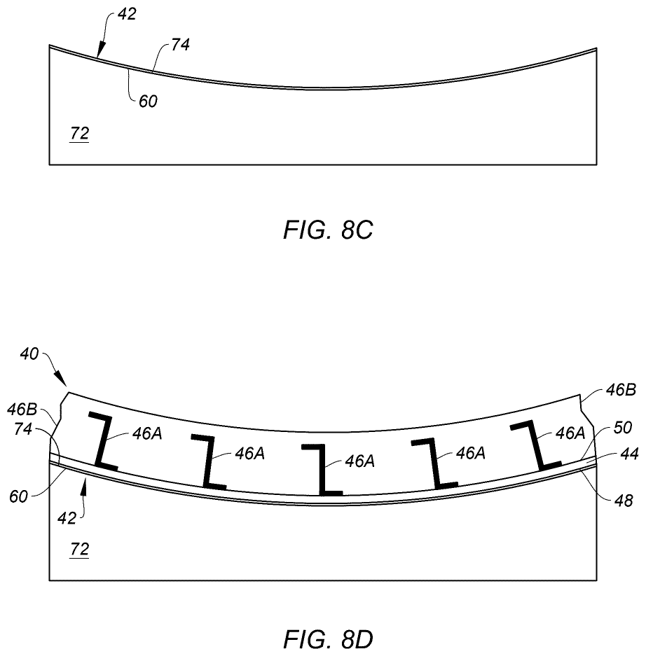

FIG. 7 is a flow diagram of a method 700 for forming a thermoplastic composite component with integrated lightning strike protection. For ease of description, the formation method 700 is described below with respect to the aircraft component 38 of FIG. 2. The formation method 700 of the present disclosure, however, may alternatively be used to form various other types, geometries and/or structural configurations of aircraft components with lightning strike protection.

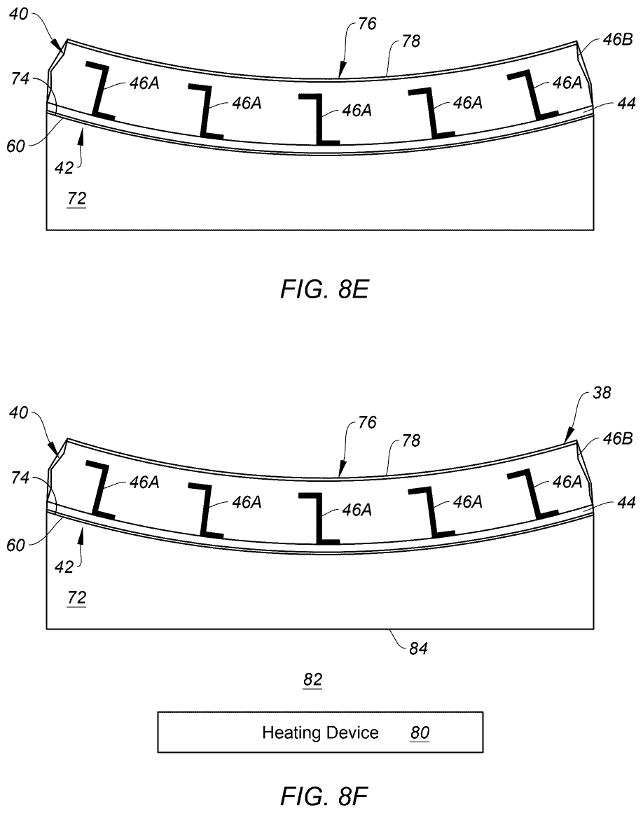

In step 702, referring to FIG. 8A, the thermoplastic composite structure 40 is provided. For case of description, the thermoplastic composite structure 40 is described below as an original manufacture (e.g., brand new) thermoplastic composite structure. For example, each individual member 44, 46A, 46B of the thermoplastic composite structure 40 may be discretely formed; e.g., laid up and consolidated. These members 44, 46A, 46B may then be arranged together and bonded to one another via one or more welding (e.g., ultrasonic welding, induction welding, vibration welding, laser welding, resistance welding, etc.) operations to form the thermoplastic composite structure 40. Alternatively, some or all of the members 44, 46A, 46B of the thermoplastic composite structure 40 may be formed integral with one another by laying up layers of those members 44, 46A, 46B together and consolidating the layers together. The present disclosure, however, is not limited to such exemplary manufacturing techniques for the thermoplastic composite structure 40. Moreover, it is contemplated the thermoplastic composite structure 40 may alternatively be a repaired thermoplastic composite structure as described below in further detail.

In step 704, referring to FIG. 8B, the LSP layer 42 is provided. At this step, the LSP layer 42 is discretely formed from and is not yet arranged with or bonded to the thermoplastic composite structure 40. This may facilitate the formation of the LSP layer 42 as well as the thermoplastic composite structure 40 using formation techniques specifically tailored to the individual construction of that aircraft component member 42, 40.

In step 706, referring to FIG. 8C, the LSP layer 42 is arranged with a thermally conductive tool 72; e.g., a metal conductor. The conductive tool 72 surface can be treated with release agent on a formation surface 74 of the tool 72. The LSP layer 42 of FIG. 8C, for example, is arranged on the formation surface 74. The LSP layer 42 may thereby overlay and engage (e.g., abut against, fully contact, etc.) the formation surface 74. At least a portion or an entirety of this formation surface 74 may have the same contour of the exterior surface 60 of the aircraft component 38 to be formed. Examples of the tool 72 include, but are not limited to, a die or a set of dies, a mold, tooling or another conductive support.

In step 708, referring to FIG. 8D, the already formed and pre-consolidated thermoplastic composite structure 40 is arranged with the LSP layer 42 and the tool 72. The thermoplastic composite structure 40 of FIG. 8D, for example, is arranged on the LSP layer 42. The thermoplastic composite structure 40 and its skin 44 may thereby overlay and engage (e.g., abut against, fully contact, etc.) the LSP layer 42. The LSP layer 42 of FIG. 8D is vertically between and may physically separate the tool 72 and its formation surface 74 from the thermoplastic composite structure 40 and its skin 44. The LSP layer 42 and the thermoplastic composite structure 40 are thereby arranged sequentially in a stack on the tool 72.

In step 710, referring to FIG. 8E, the thermoplastic composite structure 40 is biased towards the tool 72. The stack members 40 and 42 of FIG. 8E, for example, may be vacuum bagged together and against the tool 72. The LSP layer 42 is thereby preloaded (e.g., sandwiched and compressed) vertically between (a) the thermoplastic composite structure 40 and its skin 44 and (b) the tool 72 and its formation surface 74 using a vacuum bag 76, where the thermoplastic composite structure 40 and the LSP layer 42 are arranged within a vacuum bag cavity between a wall 78 of the vacuum bag 76 and the tool 72.

In step 712, referring to FIG. 8F, the LSP layer 42 is bonded to the thermoplastic composite structure 40 and its skin 44. The tool 72, for example, may be heated using a heating device 80. This heating device 80 may be arranged next to the tool 72, where the tool 72 is disposed vertically between the LSP layer 42 and the heating device 80. The heating device 80 may also be vertically spaced from the tool 72 by a gap 82; e.g., an air gap, an empty volume, etc. However, it is contemplated the heating device 80 may alternatively be abutted against or integrated into the tool 72. Examples of the heating device 80 include, but are not limited to, an infrared heating device, an electrical heating device (e.g., an electrical resistance heater), an induction/conduction device, or a gas heater which directs heated gas against a backside surface 84 of the tool 72.

The heated tool 72 heats the LSP layer 42. The heated tool 72 also heats the thermoplastic composite structure 40 and its skin 44 via thermal conduction through the heated LSP layer 42. Here, (a) the thermoplastic material of the heated LSP layer 42 and (b) the thermoplastic material in a portion of the heated thermoplastic composite structure 40 and its skin 44 adjacent the heated LSP layer 42 may be heated enough to melt that thermoplastic material for bonding the LSP layer 42 to the skin 44. The thermoplastic material, for example, may be heated enough that the thermoplastic material of the LSP layer 42 or the skin 44 softens, but not enough so as to liquify the thermoplastic material of the LSP layer 42 and the skin 44. By melting the thermoplastic material of the LSP layer 42 and the skin 44 while the thermoplastic composite structure 40 and its skin 44 are preloaded against the LSP layer 42 for a certain period of time and then (actively or passively) cooling the LSP layer 42 and the thermoplastic composite structure 40 to solidify the thermoplastic material, the LSP layer 42 is bonded to the skin 44 to form is unitary body. This unitary body may be the aircraft component 38.

In step 714, the aircraft component 38 is removed from the tool 72. The vacuum bag 76, for example, may be removed. The aircraft component 38 may then be lifted off of the tool 72.

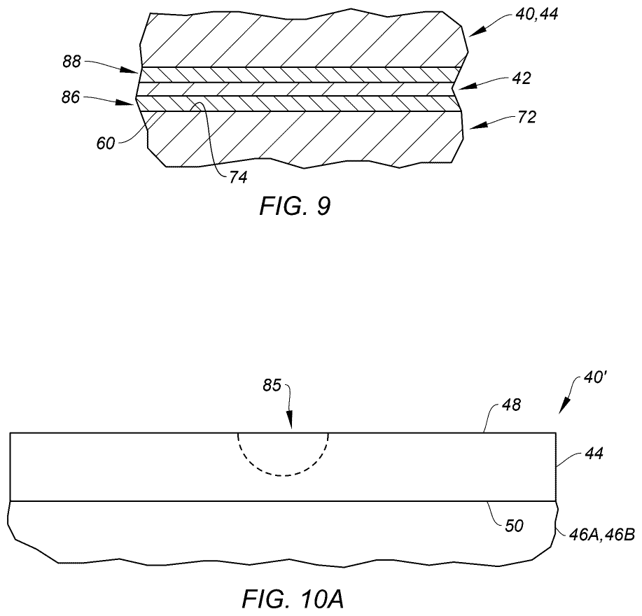

In some embodiments, referring to FIG. 8D, the LSP layer 42 may contact the tool 72 and its formation surface 74. Similarly, the LSP layer 42 may also or alternatively contact the skin 44 at its exterior surface 48. In other embodiments, referring to FIG. 9, at least (or only) one layer of thermoplastic film 86 may be disposed between and may contact the LSP layer 42 and the tool 72. At least (or only) one layer of thermoplastic film 88 may also or alternatively be disposed between and may contact the LSP layer 42 and the skin 44. Each of these layers of thermoplastic film 86, 88 may be co-bonded with the LSP layer 42 and thereby further form respective portions of the aircraft component 38.

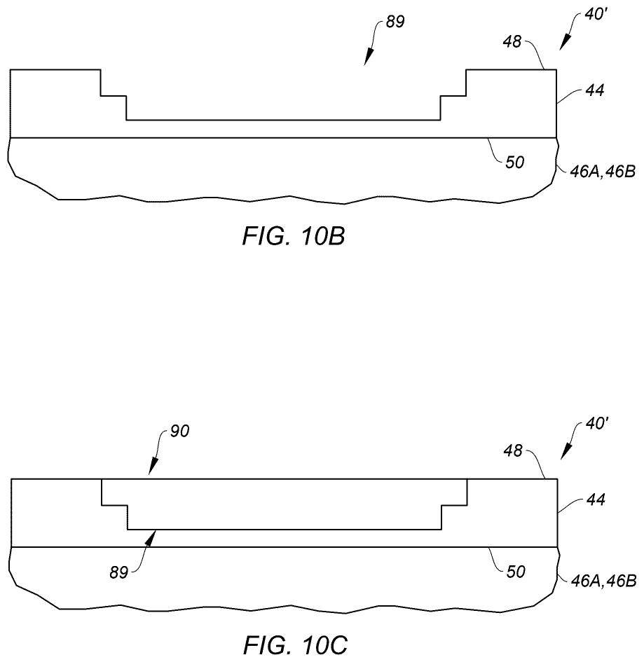

In some embodiments, referring to FIG. 8A, the thermoplastic composite structure 40 may be formed as an original manufacture thermoplastic composite structure. In other embodiments, the thermoplastic composite structure 40 may be a repaired thermoplastic composite structure. For example, referring to FIG. 10A, a damaged thermoplastic composite structure 40′ may be received. This damaged thermoplastic composite structure 40′ includes a damaged region 85 which may extend along the exterior surface 48 of the damaged thermoplastic composite structure 40′, project partially vertically into the skin 44 of the damaged thermoplastic composite structure 40′, or project vertically through the skin 44. For case of description, the damaged region 85 is described below as projecting partially vertically into the skin 44. Referring to FIG. 10B, the damaged region 85 may be partially or completely removed from the thermoplastic composite structure 40 to leave an aperture 89. Referring to FIG. 10C, the aperture 89 may be filled by a patch 90 and the patch 90 may then be bonded to the surrounding material of the thermoplastic composite structure 40 to provide the repaired thermoplastic composite structure. In other embodiments, the repaired thermoplastic composite structure may be placed upside down and the vacuum bag may be applied from the top of the repair side and the LSP layer side. Examples of the heating device 80 include, but are not limited to, an infrared heating device, an electrical heating device (e.g., an electrical resistance heater), an induction/conduction device, or a gas heater which directs heated gas against the top side of the vacuum surface.

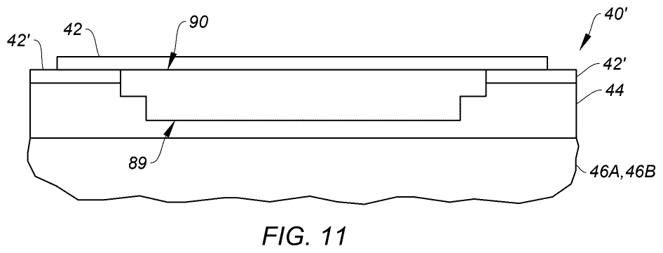

In some embodiments, referring to FIG. 11, a surface finish (e.g., a coating, a primer) may be removed from the peripheral area (e.g., 0.3-0.6 inches wide) of the repair area to expose an original LSP layer 42′ of the damaged TPC structure. The repair LSP layer 42 may then cover this peripheral area of the original LSP layer 42′ and make electrical connection between the original LSP 42′ and the repair LSP layer 42.

While various embodiments of the present invention have been disclosed, it will be apparent to those of ordinary skill in the art that many more embodiments and implementations are possible within the scope of the invention. For example, the present invention as described herein includes several aspects and embodiments that include particular features. Although these features may be described individually, it is within the scope of the present invention that some or all of these features may be combined with any one of the aspects and remain within the scope of the invention. Accordingly, the present invention is not to be restricted except in light of the attached claims and their equivalents.

What is claimed is:

1. A formation method, comprising:
arranging a lightning strike protection and thermoplastic material on a tool, the lightning strike protection comprising a plurality of interconnected conductive elements;
arranging a thermoplastic composite structure over the lightning strike protection and the thermoplastic material with the lightning strike protection and the thermoplastic material between the tool and the thermoplastic composite structure;
heating the tool to provide a heated tool; and
heating the thermoplastic material using the heated tool to melt the thermoplastic material and bond the lightning strike protection to the thermoplastic composite structure.

2. The formation method of claim 1, wherein the thermoplastic composite structure comprises second thermoplastic material and fiber reinforcement embedded within the second thermoplastic material of the thermoplastic composite structure, and the formation method further comprises:
conductive heating the thermoplastic composite structure through the lightning strike protection and the thermoplastic material using the heated tool to melt a portion of the second thermoplastic material of the thermoplastic composite structure adjacent the lightning strike protection and further bond the lightning strike protection to the thermoplastic composite structure.

3. The formation method of claim 2, wherein the thermoplastic material and the second thermoplastic material are a common type of thermoplastic material.

4. The formation method of claim 1, wherein
the heating of the tool comprises heating the tool with a heating device to provide the heated tool; and
the heated tool is disposed between the heating device and a stack of the lightning strike protection, the thermoplastic material and the thermoplastic composite structure.

5. The formation method of claim 4, wherein the heating device comprises an infrared heating device.

6. The formation method of claim 4, wherein the heating device comprises at least one of an induction heating device or a conduction heating device.

7. The formation method of claim 1, wherein the heating of the tool comprises directing a heated gas against the tool to provide the heated tool.

8. The formation method of claim 1, further comprising biasing the thermoplastic composite structure towards the heated tool to press the lightning strike protection and the thermoplastic material between the tool and the thermoplastic composite structure.

9. The formation method of claim 8, wherein the thermoplastic composite structure is biased towards the heated tool using a vacuum bag.

10. The formation method of claim 1, wherein the lightning strike protection is bonded to the thermoplastic composite structure to form an aircraft component with integrated lightning strike protection.

11. The formation method of claim 1, wherein a lightning strike protection layer comprises the lightning strike protection and the thermoplastic material, and the plurality of interconnected conductive elements are embedded within the thermoplastic material prior to arranging the lightning strike protection and the thermoplastic material on the tool.

12. The formation method of claim 11, wherein the lightning strike protection layer further comprises fiber reinforcement.

13. The formation method of claim 11, wherein at least one of
the lightning strike protection layer contacts the tool; or
the lightning strike protection layer contacts the thermoplastic composite structure.

14. The formation method of claim 1, further comprising disposing a thermoplastic film between the tool and the lightning strike protection or between the lightning strike protection and the thermoplastic composite structure, the thermoplastic film comprising the thermoplastic material.

15. The formation method of claim 1, wherein
the thermoplastic composite structure comprises a skin and a structural member connected and projecting out from the skin;
the skin is arranged over the lightning strike protection with the skin between the lightning strike protection and the structural member; and
the heating of the thermoplastic material bonds the lightning strike protection to the skin.

16. The formation method of claim 1, wherein the thermoplastic composite structure is an original manufactured part.

17. The formation method of claim 1, further comprising repairing the thermoplastic composite structure prior to performing the arranging of the thermoplastic composite structure on the lightning strike protection.

18. A formation method, comprising:
arranging a lightning strike protection layer over a metal conductor;
arranging a pre-consolidated fiber reinforced thermoplastic structure over the lightning strike protection layer with the lightning strike protection layer between the metal conductor and the pre-consolidated fiber reinforced thermoplastic structure;
heating the metal conductor to provide a heated metal conductor;
heating the lightning strike protection layer using the heated metal conductor to melt thermoplastic material of the pre-consolidated fiber reinforced thermoplastic structure and bond the lightning strike protection layer to the pre-consolidated fiber reinforced thermoplastic structure to form an aircraft component; and
removing the aircraft component from the metal conductor.

19. The formation method of claim 18, wherein the lightning strike protection layer comprises a metal mesh embedded within thermoplastic material of the lightning strike protection layer.

20. A formation method, comprising:
arranging a lightning strike protection layer over a metal conductor;
arranging a thermoplastic composite structure over the lightning strike protection layer, the thermoplastic composite structure comprising a skin and a structural member connected to and projecting out from the skin, and the lightning strike protection layer between and engaging the metal conductor and the skin;
heating the metal conductor to provide a heated metal conductor;
heating the lightning strike protection layer using the heated metal conductor to melt thermoplastic material of the thermoplastic composite structure and bond the lightning strike protection layer to the skin to form an aircraft component; and
removing the aircraft component from the metal conductor.
